(19) United States
(12) Patent Application Publication
(10) Pub. No.: US 2016/0147395 A1
(43) Pub. Date: May 26, 2016

(54) METHOD AND SYSTEM FOR SERIES-BASED DIGITAL READING CONTENT QUEUE AND INTERFACE

(71) Applicant: Kobo Incorporated, Toronto (CA)

(72) Inventor: Hufsa TAHIR, Mississauga (CA)

(73) Assignee: KOBO INCORPORATED, Toronto (CA)

(21) Appl. No.: 14/550,797

(22) Filed: Nov. 21, 2014

(51) Int. Cl. G06F 3/0483; G06F 17/30; G06Q 30/06; H04L 29/08

(52) U.S. Cl. CPC G06F 3/0483; H04L 67/10; G06F 17/30011; G06Q 30/0633

(57) ABSTRACT

A method and system for implementing a series-based digital reading content queue and interface is provided. The method searches books in an e-library for series information; sorts books with related series information into a predefined order; develops a series overview icon to represent the books with related series information, for presentation on a series page; and automatically providing access to all available books with related series information when the series overview icon is selected.

### TECHNICAL FIELD

Examples described herein relate to a method and system for series-based digital reading content queue and interface.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device, in an embodiment.

FIG. 2 illustrates an example architecture configuration of a computing device, according to an embodiment.

FIG. 3A illustrates a block diagram of an exemplary library page on an e-reader, according to an embodiment

FIG. 3B illustrates a block diagram of an exemplary series page on an e-reader, according to an embodiment.

FIG. 3C illustrates a block diagram of an exemplary page for a designated series on an e-reader, according to an embodiment.

FIG. 4 illustrates a block diagram of an exemplary automatic series manager, according to an embodiment

FIG. 5 illustrates a method of implementing a series-based digital reading content queue and interface, according to an embodiment.

FIG. 6 illustrates an exemplary computer system for implementing an image centric mobile application, according to an embodiment.

### DETAILED DESCRIPTION

A method and system for series-based digital reading content queue and interface is provided. The method searches books in an electronic library for series information. One embodiment sorts books with related series information into predefined order. In addition, a series overview icon is developed to represent the books with related series information, for presentation on a series page. One embodiment automatically provides access to all available books with related series information when a series overview icon is selected.

In one embodiment, a series section is provided in a user' e-library, with a “playlist” or e-reading list, for each series of books owned by user. The automatic series manager detects series e-books using methods such as scouring metadata tags for series information of e-books the user has in their library; using a smart search when series metadata of some e-books is missing or left blank, and the like. In one embodiment, smart search is a title search that will search titles of every book for a match to a series name, eliminating or at least minimizing any chances of missing e-books that may be fact be in series. In another embodiment, when no series metadata or matching name in title is found, a user may develop a customized series list by adding and/or remove titles to create a custom series list. In one embodiment, the user may also add a series title or customize series titles.

In one embodiment, using the series info in metadata of the flagged e-books series, the system sorts books in chronological order, for presentation to a user in that same order for e-reading. However, in another embodiment, the presentation may be sorted alphabetically, dragged into order by a user, or the like. In one embodiment, the series home page looks like a grid, such as for example, with only the cover of first book in each series and the series name visible. Selecting a cover leads to an expanded view showing a list of books in that series. In one embodiment, there may also be a “Begin Reading” button to start the chain of books. For purposes of the following discussion, e-books can include e-books, e-magazines, pdf's, e-comics and the like.

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books).

Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

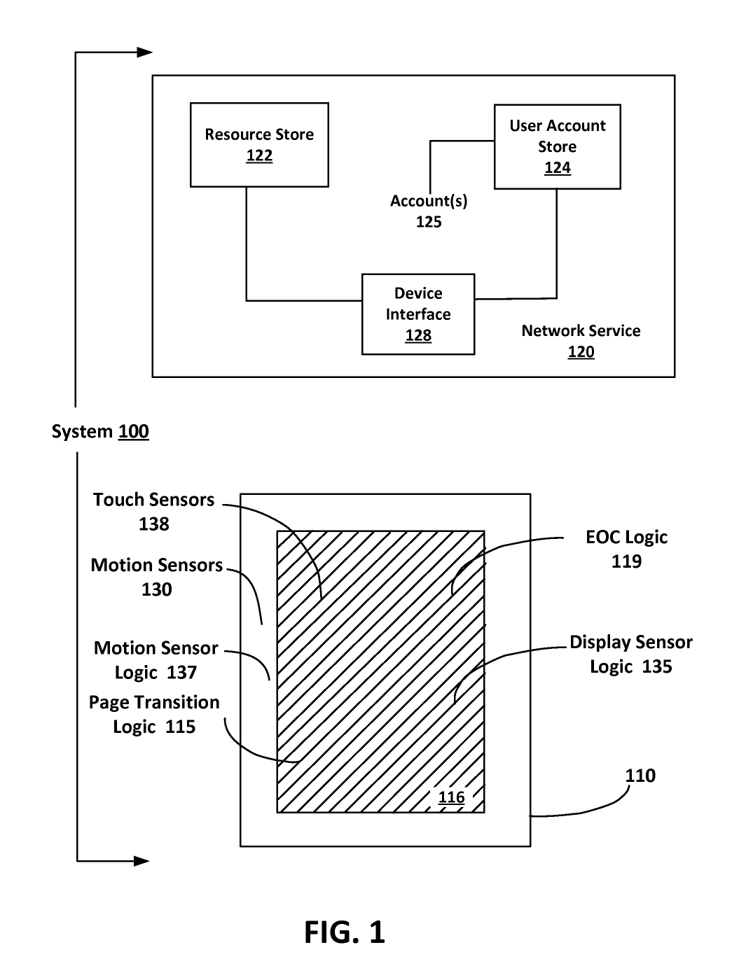

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services that communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and an optional housing, not shown. In an embodiment, the display screen 116 is touch-sensitive, to process touch inputs including gestures (e.g., swipes). For example, the display screen 116 may be integrated with one or more touch sensors 138 to provide a touch-sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing can be integrated with touch sensors to provide one or more touch sensing regions, for example, on the bezel and/or back surface of the housing.

E-reading device 110 can also include one or more motion sensors 130 arranged to detect motion imparted thereto, such as by a user while reading or in accessing associated functionality. In general, the motion sensor(s) 130 may be selected from one or more of a number of motion recognition sensors, such as but not limited to, an accelerometer, a magnetometer, a gyroscope and a camera. Further still, motion sensor 130 may incorporate or apply some combination of the latter motion recognition sensors.

E-reading device 110 further includes motion gesture logic 137 to interpret user input motions as commands based on detection of the input motions by motion sensor(s) 130. For example, input motions performed on e-reading device 110 such as a tilt, a shake, a rotation, a swivel or partial rotation and an inversion may be detected via motion sensors 130 and interpreted as respective commands by motion gesture logic 137.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state In the specific example embodiment where a given page state coincides with a single page, for instance, each page state corresponding to one page of the digitally constructed series of pages paginated to comprise, in one embodiment, an e-book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state.

For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116. Although discussed in context of “taps” herein, it is contemplated that a gesture action provided in sufficient proximity to touch sensors of display screen 116, without physically touching thereon, may also register as a “contact” with display screen 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display screen 116, otherwise known as a touch event. More specifically, display sensor logic 135 can detect a touch events also referred to herein as a tap, an initial tap held in contact with display screen 116 for longer than some pre-defined threshold duration of time (otherwise known as a “long press” or a “long touch”), multiple taps performed either sequentially or generally simultaneously, swiping gesture actions made through user interaction with the touch sensing region of the display screen 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

The term “sustained touch” is also used herein and refers to a touch event that is held in sustained contact with display screen 116, during which sustained contact period the user or observer may take additional input actions, including gestures, on display screen 116 contemporaneously with the sustained contact. Thus a long touch is distinguishable from a sustained touch, in that the former only requires a touch event to be held for some pre-defined threshold duration of time, upon expiration of which an associated input command may be automatically triggered.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display screen 116 for the purpose of associating respective input commands therewith.

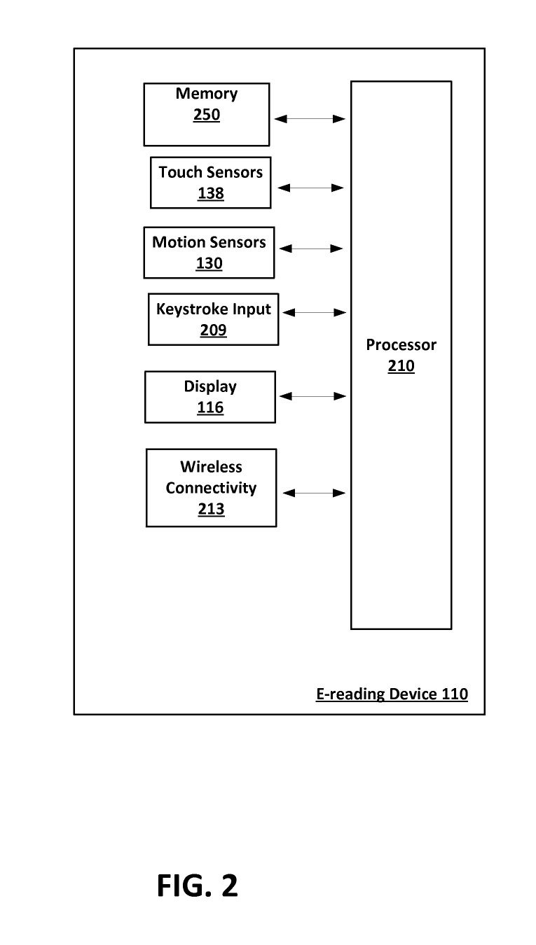

FIG. 2 illustrates further detail of e-reading device 110 as described above with respect to FIG. 1, in an embodiment. E-reading device 110 further includes processor 210, a memory 250 storing instructions and logic pertaining at least to display sensor logic 135, and page transition logic 115.

Processor 210 can implement functionality using the logic and instructions stored in memory 250. Additionally, in some implementations, processor 210 utilizes the network interface 220 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 120. The application resources 221 that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 209 such as from a virtual or rendered keyboard, and other input mechanisms 299 (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic module 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which computing device 110 is intended to operate, such as in accordance with Wi-Fi, Bluetooth, Near Field Communication (NFC) communication protocols, and the like.

Series section 303 can be implemented as a software module, comprising instructions stored in memory 250, on mobile computing device 110. One or more embodiments of series section 303 described herein may be implemented using programmatic modules or components, a portion of a program, or software in conjunction with one or more hardware component(s) capable of performing one or more stated tasks or functions. As used herein, such module or component can exist on a hardware component independently of other modules or components. Alternatively, a module or component can be a shared element or process of other modules, programs or machines.

Display screen 116 of computing device 110 includes touch functionality whereby user input commands may be accomplished via gesture actions performed at display screen 116. In the context of reading digitally rendered pages comprising content of an e-book, for example, come common input commands accomplished via gesture actions received at display screen 116 may include, for example, page turns, making annotations, adjusting illumination levels or contrast of the device display screen, and re-sizing the font size of text in the content.

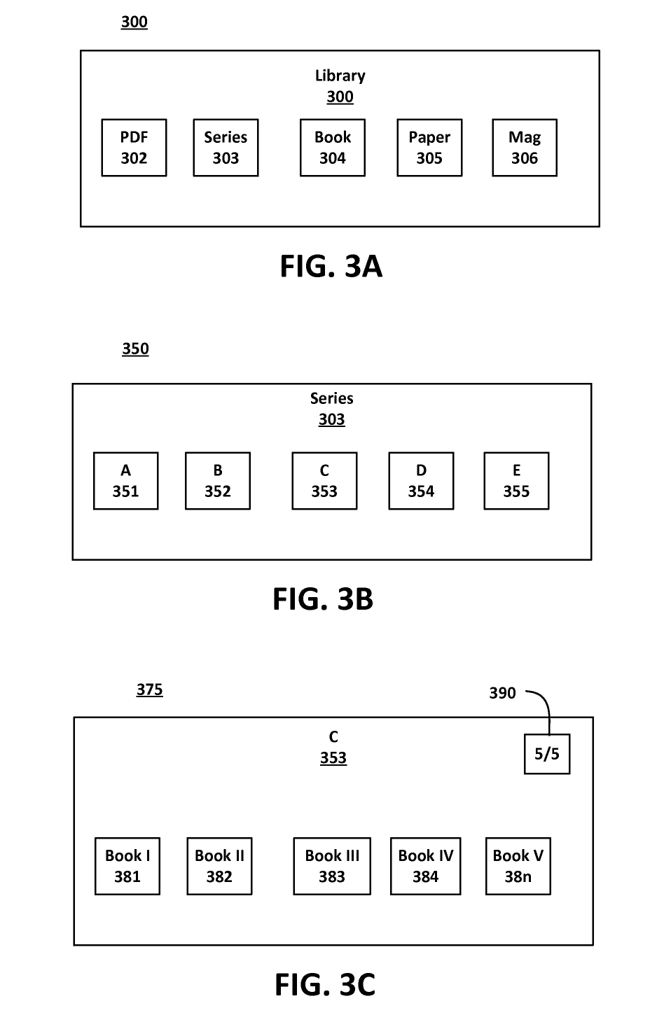

FIG. 3A illustrates a block diagram of an exemplary library page 300 on an e-reader 110, according to an embodiment. In one embodiment, a list of user available reading options 302-306 are maintained. For example, the library page 300 is a high level view of the different types of media stored on the e-reading device 110. For example, in one embodiment, library page 300 includes PDF's 302, series 303, books 304 and papers 305 and magazines 306. Although only five different types of materials are shown on library page 300, the present technology is well suited to more or fewer options at the Library page 300. Moreover, in another embodiment, library page 300 may include a number of pages that may be accessed by swipes or the like.

FIG. 3B illustrates a block diagram of an exemplary series page 350 on an e-reader 110, according to an embodiment. In one embodiment, series page 350 includes series 351-35n. In one embodiment, series 351-35n represents different book series. However, in another embodiment, series 351-35n can represent books, magazines, and the like. For example, a magazine series may be sorted based on their subscription and may include a cover and a title.

In one embodiment, series page 350 is laid out in a grid where each of series 351-355 shows a cover of the first book in each series and the series name. Although one embodiment describes the layout as a grid, other types of layouts may be considered. Moreover, although one embodiment describes the each of series 351-355 having a cover of the first book and the title of the series, that may be modified. For example, if the first book in series 352 has been read, the cover of the second book in the series may be shown in series page 350 with the series title and/or the specific book title. In one embodiment, series page 350 also includes series recommendation 35n. In general, series recommendation 35n provides recommendations for other series that are available in the store.

FIG. 3C illustrates a block diagram of an exemplary designated series page 375 on an e-reader 110, according to an embodiment. In one embodiment, designated series page 375 includes the books within a certain series. For example, on page 375, series 353 is shown. In one embodiment, series 353 includes five books 381-385. In one embodiment, the books on designated series page 375 are laid out in a grid where each of the books 381-385 includes a cover and the specific book name. Although one embodiment describes the layout as a grid, other types of layouts may be considered.

Moreover, although one embodiment shows each of books 381-385 in order of the series, in another embodiment that order may be modified. For example, if the first book 381 has been read, the image of first book 381 may be modified to show that it has been read, it may be moved to the end of the list of books, or the like. Moreover, in one embodiment designated series page 375 may include series indicator 390. For example, if the series is 5 books in length and all five books are in library 300, series indicator 390 would show 5/5, that is 5 of 5 books are available. Similarly, if only 4 books out of the 5 in the series were in library 300, series indicator 390 would show 4/5, thereby indicating that a book from the series was missing.

In another embodiment, if the series is a magazine series, designated series page 375 may sort the available magazine issues in chronological order. Moreover, in one embodiment, the number of issues that are presented on designated series page 375 may be based on a pre-defined time period, e.g., a year; a user defined time period, e.g., 6 months; all available issues, and the like.

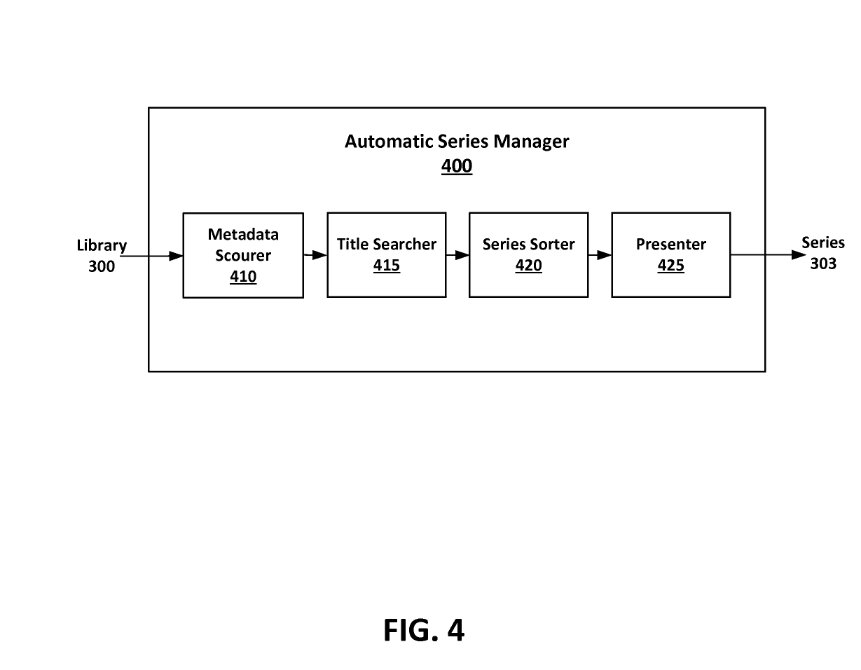

FIG. 4 illustrates a block diagram of an exemplary automatic series manager 400, according to an embodiment. In one embodiment, by using automatic series manager 400 a user doesn't have to browse or search for next book in a series. Similarly, a user doesn't need to remember titles for every book in a series. In one embodiment, using automatic series manager 400 allows a series to be read seamlessly, with no need to navigate back to library page. Moreover, using series page 350, each of the different series in the library 300 can be reviewed collectively. For example, automatic series manager 400 will access a library 300, determine if any of the electronic content are series, e.g., books, magazines, and the like; and then provide the series information in a format such as series page 350 of FIG. 3B.

In one embodiment, automatic series manager 400 includes a metadata scourer 410, a title searcher 415, a series sorter 420, and a presenter 425. In one embodiment, metadata scourer 410 detects series via scouring metadata tags for series information on books the user has in their library 300. In one embodiment, the scouring includes sideloaded content. In one embodiment, library title search 415 can be used in conjunction with metadata scourer 410 or when series metadata is missing. For example, title searcher 415 will search titles of every book for a match to a series name, ensuring a least possible chance of missing books in series. In one embodiment, the match is an exact match to the series name. In one embodiment, series sorter 420 sorts the books in chronological order, for presentation in the same order for e-reading. In another embodiment, series sorter 420 will sort the book based on other metrics such as, but not limited to, alphabetically, dragged into order by a user, and the like. Presenter 425 develops a series overview icon to represent the books with related series information, for presentation on series page 350.

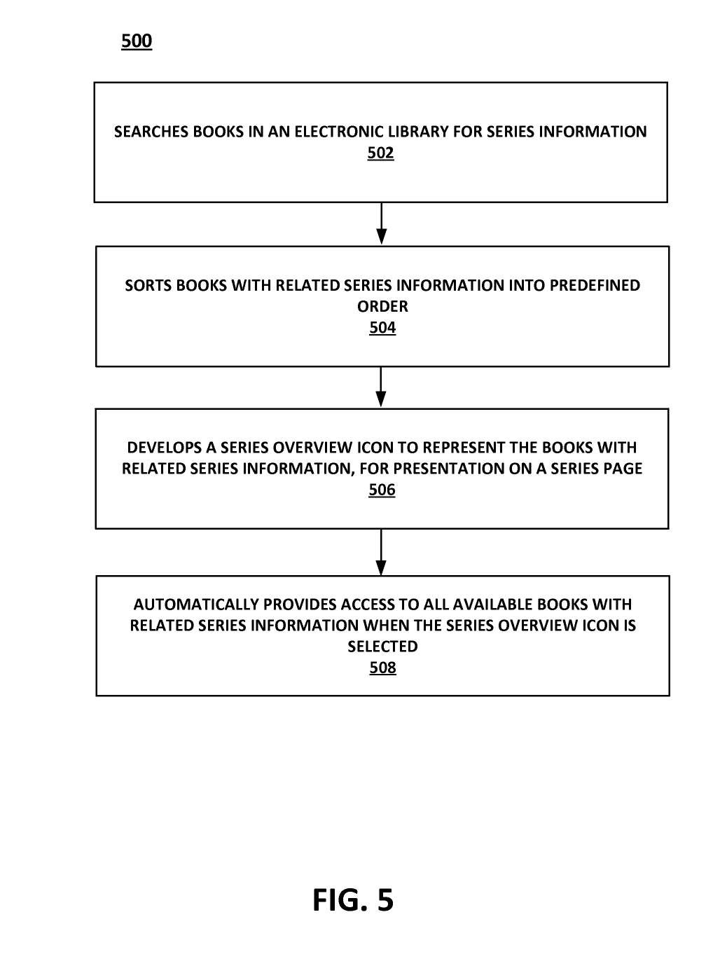

FIG. 5 illustrates a method 500 of implementing a series-based digital reading content queue and interface, according to an embodiment.

Referring now to 502 of FIG. 5, one embodiment searches books in an electronic library 300 for series information. In one embodiment, metadata scourer 410 of automatic series manager 400 is used to scour metadata tags for series information on books the user has in their library as described herein. In one embodiment, the scouring includes sideloaded content. In one embodiment, library title search 415 can be used in conjunction with metadata scourer 410 or when series metadata is missing. For example, library title search 415 will search titles of every book for a match to a series name, ensuring a least possible chance of missing books in series.

With reference now to 504 of FIG. 5, one embodiment sorts books with related series information into predefined order. For example, in one embodiment series sorter 420 sorts the books in chronological order, for presentation in the same order for e-reading. In another embodiment, series sorter 420 will sort the book based on other metrics such as, but not limited to, alphabetically, dragged into order by a user, and the like.

Referring now to 506 of FIG. 5, one embodiment develops a series overview icon to represent the books with related series information, for presentation on a series page. For example, as shown in series page 350 of FIG. 3B, in one embodiment, series 351-35n represents different book series. However, in another embodiment, series 351-35n can represent books, magazines, comic books, scholarly articles, PDF's and the like. For example, a magazine series may be sorted based on their subscription and may include a cover and a title. Similarly, a scholarly article series may be sorted based on their publication date, publisher information, or the like and may include a cover and a title.

With reference now to 508 of FIG. 5, one embodiment automatically provides access to all available books with related series information when the series overview icon is selected. For example, as shown in FIG. 3C, in one embodiment, designated series page 375 includes the books within a certain series. For example, on page 375, each of the e-books in series 353 is shown where each of the books 381-385 includes a cover and the specific book name. Although one embodiment shows each of books 381-385 in order of the series, in another embodiment that order may be modified. For example, if the first book 381 has been read, the image of first book 381 may be modified to show that it has been read, it may be moved to the end of the list of books, or the like.

Moreover, as described herein, in one embodiment designated series page 375 may include series indicator 390. For example, if the series is 3 books in length and all three books are in library 300, series indicator 390 would show 3/3, that is all 3 of the books are available. Similarly, if only 2 books out of the 3 in the series were in library 300, series indicator 390 would show 2/3, thereby indicating that a book from the series was missing.

In another embodiment, if the series is a magazine series, designated series page 375 may sort the available magazine issues in chronological order. Moreover, in one embodiment, the number of issues that are presented on designated series page 375 may be based on a pre-defined time period, e.g., a year; a user defined time period, e.g., 6 months; all available issues, and the like.

In one embodiment, upon reaching an end of a book with related series information, the e-reader will provide an option, such as, but not limited to, continuing to the next book in the series, purchasing the next book in the series, e.g., when it is not in the e-reader library, adding the next book to a wishlist, a recommendation for a different series to read, returning to the series page, and the like. For example, in one embodiment, if the next book is not available in the user's library 300, the option to buy the book will take the user to a book's store page. Once the book is purchased, it is added to library 300 and then will be automatically added to the series list as described herein. In addition, the e-reader will then present the newly purchased book. That is, the front cover of the newly purchased book will be presented to the user as it is the next book in the series.

### Example Computer System Environment

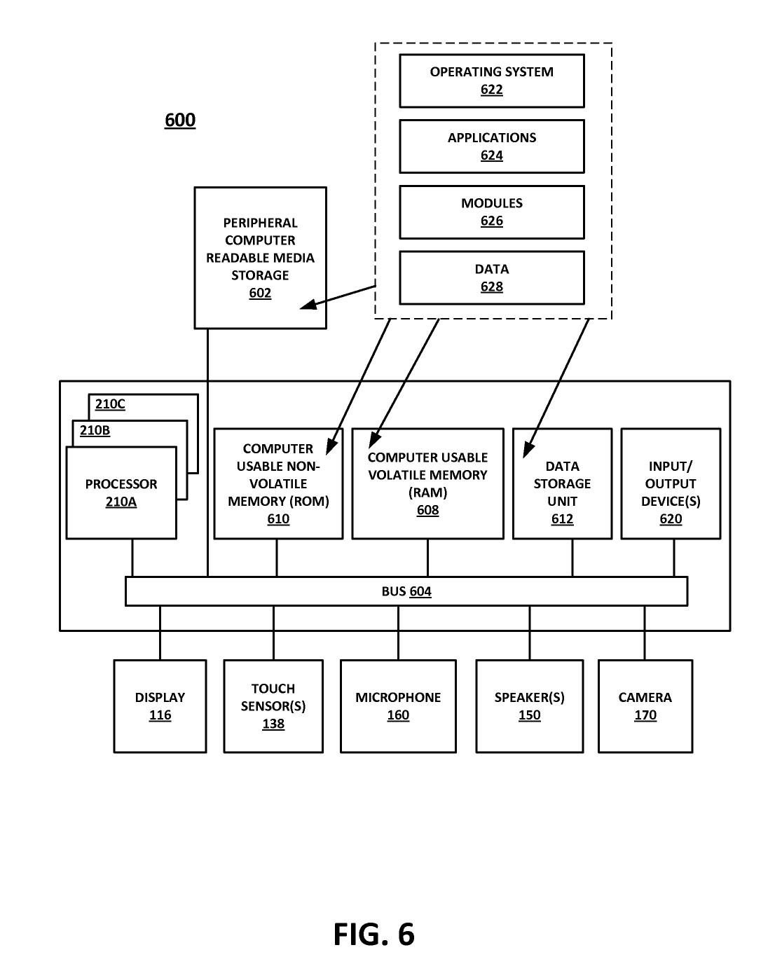

With reference now to FIG. 6, all or portions of some embodiments described herein are composed of computer-readable and computer-executable instructions that reside, for example, in computer-usable/computer-readable storage media of a computer system. That is, FIG. 6 illustrates one example of a type of computer (computer system 600) that can be used in accordance with or to implement various embodiments of an e-Reader, such as e-Reader 110, which are discussed herein. It is appreciated that computer system 600 of FIG. 6 is only an example and that embodiments as described herein can operate on or within a number of different computer systems.

System 600 of FIG. 6 includes an address/data bus 604 for communicating information, and a processor 210A coupled to bus 604 for processing information and instructions. As depicted in FIG. 6, system 600 is also well suited to a multi-processor environment in which a plurality of processors 210A, 210B, and 210C are present. Processors 210A, 210B, and 210C may be any of various types of microprocessors. For example, in some multi-processor embodiments, one of the multiple processors may be a touch sensing processor and/or one of the processors may be a display processor. Conversely, system 600 is also well suited to having a single processor such as, for example, processor 210A.

System 600 also includes data storage features such as a computer usable volatile memory 608, e.g., random access memory (RAM), coupled to bus 604 for storing information and instructions for processors 210A, 210B, and 210C. System 600 also includes computer usable non-volatile memory 610, e.g., read only memory (ROM), coupled to bus 604 for storing static information and instructions for processors 210A, 210B, and 210C. Also present in system 600 is a data storage unit 612 (e.g., a magnetic or optical disk and disk drive) coupled to bus 604 for storing information and instructions.

Computer system 600 of FIG. 6 is well adapted to having peripheral computer-readable storage media 602 such as, for example, a floppy disk, a compact disc, digital versatile disc, universal serial bus “flash” drive, removable memory card, and the like coupled thereto. In some embodiments, computer-readable storage media 602 may be coupled with computer system 600 (e.g., to bus 604) by insertion into removable a storage media slot.

System 600 also includes or couples with display 116 for visibly displaying information such as alphanumeric text and graphic images. In some embodiments, system 600 also includes or couples with one or more optional touch sensors 138 for communicating information, cursor control, gesture input, command selection, and/or other user input to processor 210A or one or more of the processors in a multi-processor embodiment. In some embodiments, system 600 also includes or couples with one or more optional speakers 150 for emitting audio output. In some embodiments, system 600 also includes or couples with an optional microphone 160 for receiving/capturing audio inputs. In some embodiments, system 600 also includes or couples with an optional digital camera 170 for receiving/capturing digital images as an input.

Optional touch sensor(s) 138 allows a user of computer system 600 (e.g., a user of an eReader of which computer system 600 is a part) to dynamically signal the movement of a visible symbol (cursor) on display 116 and indicate user selections of selectable items displayed. In some embodiment other implementations of a cursor control device and/or user input device may also be included to provide input to computer system 600, a variety of these are well known and include: trackballs, keypads, directional keys, and the like.

System 600 is also well suited to having a cursor directed or user input received by other means such as, for example, voice commands received via microphone 160. System 600 also includes an input/output (I/O) device 620 for coupling system 600 with external entities. For example, in one embodiment, I/O device 620 is a modem for enabling wired communications or modem and radio for enabling wireless communications between system 600 and an external device and/or external network such as, but not limited to, the Internet. I/O device 620 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 6, various other components are depicted for system 600. Specifically, when present, an operating system 622, applications 624, modules 626, and/or data 628 are shown as typically residing in one or some combination of computer usable volatile memory 608 (e.g., RAM), computer usable non-volatile memory 610 (e.g., ROM), and data storage unit 612. For example, modules 626 may include an application module for providing an image based decision platform for a user.

In some embodiments, all or portions of various embodiments described herein are stored, for example, as an application 624 and/or module 626 in memory locations within RAM 608, ROM 610, computer-readable storage media within data storage unit 612, peripheral computer-readable storage media 602, and/or other tangible computer readable storage media.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. An automatic series manager for series-based digital reading content queue and interface comprising:
a metadata scourer to scour a metadata tag for series information for each book in an e-reader library;
a title searcher to search a title for each book in the e-reader library for a match to a series name;
a series sorter to sort each book identified as being part of a series; and
a presenter to present the series for e-reading.

2. The automatic series manager of claim 1 wherein said metadata scourer scours sideloaded content for series information for each book in the e-reader library.

3. The automatic series manager of claim 1 wherein each book in the library is a purchased book.

4. The automatic series manager of claim 1 wherein each book in the e-reader library is selected from the group consisting of: an e-book, an e-magazine, an e-comic book, a PDF, and a scholarly article.

5. The automatic series manager of claim 1 wherein the series sorter sorts each book identified as being part of the series in chronological order for presentation.

6. The automatic series manager of claim 1 wherein the presenter develops a series overview icon to represent the books with related series information.

7. The automatic series manager of claim 6 wherein the series overview icon is presented on a series page.

8. A computing device comprising:
a memory that stores a set of instructions;
a display screen having touch functionality;
a processor that access the instructions in memory, the processor further configured to implement a method for implementing a series-based digital reading content queue and interface comprising:
searching books in an e-library for series information;
sorting books with related series information into a predefined order;
developing a series overview icon to represent the books with related series information, for presentation on a series page; and
automatically providing access to all available books with related series information when the series overview icon is selected.

9. The computing device of claim 8 further comprising:
utilizing a metadata scourer to scour a metadata tag for series information for each book in the e-library.

10. The computing device of claim 8 further comprising:
utilizing a metadata scourer to scour a sideloaded content for series information for each book in the e-library.

11. The computing device of claim 8 further comprising:
utilizing a title searcher to search a title for each book in the e-library for a match to a series name to determine series information.

12. The computing device of claim 8 further comprising:
sorting the books with related series information in chronological order for presentation.

13. The computing device of claim 8 further comprising:
sorting the books with related series information in alphabetical order for presentation.

14. The computing device of claim 8 further comprising:
providing an indicator showing whether or not all books presently in the series are available.

15. A method for implementing a series-based digital reading content queue and interface, said method comprising:
searching books in an e-library for series information;
sorting books with related series information into a predefined order;
developing a series overview icon to represent the books with related series information, for presentation on a series page; and
automatically providing access to all available books with related series information when the series overview icon is selected.

16. The method of claim 15 further comprising:
utilizing a metadata scourer to scour a metadata tag for series information for each book in the e-library.

17. The method of claim 15 further comprising:
utilizing a metadata scourer to scour a sideloaded content for series information for each book in the e-library.

18. The method of claim 15 further comprising:
utilizing a title searcher to search a title for each book in the e-library for a match to a series name to determine series information.

19. The method of claim 15 further comprising:
sorting the books with related series information in a user defined order for presentation.

20. The method of claim 15 further comprising:
utilizing a cover of a first book in each series and a series name as the series overview icon.

21. The method of claim 15 further comprising:
upon reaching an end of a book with related series information, providing an option from the group consisting of: an option to continue to a next book in the series, an option to purchase the next book in the series, a recommendation for a different series, and an option to return to the series page.
